(19) United States
(12) Patent Application Publication
(10) Pub. No.: US 2004/0203278 A1
(43) Pub. Date: Oct. 14, 2004

(54) [SIGNAL TRANSMISSION CABLE]

(76) Inventors: CHIH-WEN LIN, TAIPEI HSIEN (TW); LESLIE DOTSON, ANAHEIM, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/250,238

(22) Filed: Jun. 17, 2003

(30) Foreign Application Priority Data
Apr. 11, 2003 (TW) 92205701

(51) Int. Cl. H01R 11/00

(52) U.S. Cl. 439/502

(57) ABSTRACT

A signal transmission cable is disclosed. The cable comprises a plurality of connectors and a cable unit wherein these connectors are coupled with each other by the cable unit. These connectors of the cable in parallel connection are respectively connected to connectors of a computer host of a PC. Therefore, one other connector of the cable could provide a few times the quantity of electric current supplied by each of the connectors of the computer host so that the cable could provide enough drive current to an extended peripheral like an extended optical disk drive.

### CROSS REFERENCE TO RELATED APPLICATIONS

This application claims the priority benefit of Taiwan application serial no.92205701, filed on Apr. 11, 2003.

### BACKGROUND OF INVENTION

1. Field of Invention

The present invention generally relates to a signal transmission cable, and more particularly, to a signal transmission cable that can provide a high drive current.

2. Description of Related Art

Accompanying the great progress of the electronic technology industry, computers with versatile functions have deeply penetrated into our work and life. There are different types of the personal computers (PC) now, from the early desktop computer and laptop computer, to the more recently developed notebook, and even to the tablet PC and the dual-function computer (i.e. the notebook integrated with the table PC″s function) that have just come out. By the included hardware components, notebooks can be divided into the full-function type, super-slim type, and mini type, depending on whether the notebook comprises a hard disk drive, an optical disk drive, and a floppy disk drive. The full-function notebook has all three axis, i.e. the hard disk drive, the optical disk drive, and the floppy disk drive; the super-slim notebook has two axis, i.e. the spinning axis of the hard disk drive and the optical disk drive, and its floppy disk drive is externally connected; and the mini notebook only has a single axis, i.e. the hard disk drive, and its optical disk drive and the floppy disk drive are externally connected. To be noted, since the size and weight of the full-function notebook is bigger, for the mobile worker, the super-slim notebook (i.e. the dual-axis type) or the mini notebook (i.e. the single-axis type) would be a better choice.

In order to have the single-axis type notebook use CD-ROM, or to have the PC that does not have a built-in CD-RW (e.g. the desktop computer or the notebook, etc.) but can burn CDs, different types of external optical disk drives have been developed and come out. In this way, a PC can perform the operation of reading in and writing out digital data from/to the CD by using the external optical disk drive. Further, since the development of the PnP (Plug and Play) connection interface, like the USB (Universal Series Bus) and the IEEE 1394 (the connection interface specification defined by IEEE), when the PC (e.g. desktop computer and notebook, etc.) has these types of the connection interface, the PC can use external peripherals, such as the optical disk drive, floppy disk drive, keyboard, mouse, scanner, and printer, etc. via the PnP connection interface without having to reboot the system.

The external optical disk with the USB connection interface is exemplified herein, since the electric current needed for driving the external optical disk drive is about 1 A, and the USB connection interface can only provide a current of about 500 mA. Therefore, besides containing a general USB type of signal transmission cable, external optical disk drive also has to contain a transformer for providing the electric power, so as to provide the drive current to the external optical disk drive. Accordingly, the signal transmission cable and the transformer corresponding to the external optical disk drive have to be used when the external optical disk drive is operated. Since the transformer has some specific limitation in its size and weight, it causes a lot of inconvenience when using the external optical disk drive, such as the inconvenience of carrying and storing it.

### SUMMARY OF INVENTION

To solve the problem mentioned above, the object of the present invention is to provide a signal transmission cable. A plurality of cable connectors connected with each other in parallel are respectively connected to a plurality of connectors of a computer host of a PC. Therefore, one of the other connectors of the signal transmission cable can provide the quantity of electric current supplied by each of the connectors of the computer host.

In order to achieve the object mentioned above, a signal transmission Cable provided by the present invention at least comprises a first connector, a second connector, a third connector, and a cable unit. Wherein, the first connector comprises a first power terminal, a first grounding terminal, and at least a first signal terminal. The second connector comprises a second power terminal, a second grounding terminal, and at least a second signal terminal. The third connector comprises a third power terminal, and a third grounding terminal. Further, the first power terminal, the second power terminal, and the third power terminal are coupled with each other via the cable unit. The first grounding terminal, the second grounding terminal, and the third grounding terminal are coupled with each other via the cable unit. The first signal terminal and the second signal terminal are coupled with each other via the cable unit.

As described in the preferred embodiment according to the present invention, the first connector, the second connector, and the third connector are male connectors or female connectors, and the connection interface of the first connector, the second connector, and the third connector is USB.

As described in the preferred embodiment according to the present invention, the signal transmission cable further comprises a fourth connector. The fourth connector comprises a fourth power terminal, a fourth grounding terminal, and at least a fourth signal terminal. The third connector further comprises a third signal terminal. The fourth power terminal is coupled to the second power terminal via the cable unit, the fourth grounding terminal is coupled to the second power terminal via the cable unit, and the fourth signal terminal is further coupled to the second signal terminal via the cable unit. Furthermore, the fourth connector is a male connector or a female connector, and the connection interface of the fourth connector is a USB.

As described in the preferred embodiment according to the present invention, the signal transmission cable further comprises a power supply module. Wherein, the power supply module is coupled between the first power terminal and the second power terminal via the cable unit. Further, the power supply module is coupled between the first power terminal and the third power terminal via the cable unit. Furthermore, the power supply module may be a rechargeable battery module.

In summary, the signal transmission cable provided by the present invention mainly uses a plurality of connectors. The plurality of cable connectors connected with each other in parallel are respectively connected to a plurality of connectors of a computer host of a PC. Therefore, one other connector of the signal transmission cable can provide a multiple of the quantity of electric current supplied by each of the connectors of the computer host.

### BRIEF DESCRIPTION OF DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A schematically shows a diagram of a signal transmission cable of a preferred embodiment according to the present invention.

FIG. 1B schematically shows an internal circuit layout diagram of the signal transmission cable in FIG. 1A.

FIG. 2A schematically shows a diagram of a second type signal transmission cable of a preferred embodiment according to the present invention.

FIG. 2B schematically shows an internal circuit layout diagram of the signal transmission cable in FIG. 2A.

FIG. 3A schematically shows a diagram of a third type signal transmission cable of a preferred embodiment according to the present invention.

FIG. 3B schematically shows an internal circuit layout diagram of the signal transmission cable in FIG. 3A.

### DETAILED DESCRIPTION

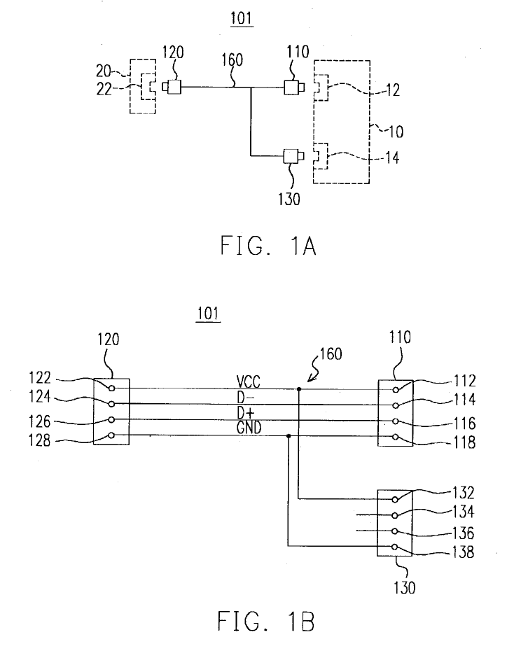

Referring to FIG. 1A, it schematically shows a diagram of a signal transmission cable of a preferred embodiment according to the present invention. The signal transmission cable 101 comprises a connector 110, a connector 120, a connector 130, and a cable unit 160. The connection interface of the connector 110, the connector 120, and the connector 130 is a PnP connection interface such as USB or IEEE 1394. However, it is not limited to the connection interfaces mentioned above, other type of the connection interface that do not support PnP function also can be applied in the present invention. Further, the computer host 10 of the PC (e.g. desktop computer, notebook, tablet PC, or dual-function computer) at least comprises a connector 12 and a connector 14. Wherein, the connection interface type of the connector 14 is the same as the connection interface type of the connector 110 and the connector 120, so that the connector 110 and the connector 120 are correspondingly coupled to the connector 12 and the connector 14, respectively. Furthermore, an external peripheral 20, such as an external optical disk drive, at least comprises a connector 22. The connection interface type of the connector 22 is the same as the connection interface type of the connector 120, so that the connector 120 is correspondingly coupled to the connector 22. To be noted, when the connectors 110, 120, 130 are the male connectors, the corresponding connectors 12, 14, 22 must be female connectors as shown in FIG. 1A. Contrariwise, when the connectors 110, 120, 130 are female connectors, the corresponding connectors 12, 14, 22 must be male connectors.

Referring to FIG. 1A, assuming that the connection interface type of the connectors (110, 120, and 130) and the connectors (12, 14, and 22) are all USB, based on the limitation of the USB connection interface specification, the electric current provided by single USB connector is about 500 mA. Therefore, when the external peripheral 20 is an external optical disk drive, the drive current of the external peripheral 20 (i.e. the external optical disk drive) is about 1 A. If the conventional one-on-one signal transmission cable (i.e. the signal transmission cable 101 that does not comprise the third connector 130) is used, a transformer for providing additional electric power is needed so as to provide drive current to the external peripheral 20. However, the present invention uses dual USB connectors (110 and 130) to provide two times quantity of electric current, i.e. providing a current of 500 mA×2=1 A, to another connector 120 while the conventional one-on-one signal transmission method is still used for signal transmission between the computer host 10 and the external peripheral 20.

For clearly describing the circuit layout of the signal transmission cable 101 of FIG. 1A, please refer to FIG. 1B, which schematically shows an internal circuit layout diagram of the signal transmission cable in FIG. 1A. The USB connection interface is similarly exemplified herein. The connector 110 comprises a power terminal 112, a signal terminal 114, a signal terminal 116, and a grounding terminal 118. The connector 120 comprises a power terminal 122, a signal terminal 124, a signal terminal 126, and a grounding terminal 128. The connector 130 comprises a power terminal 132, a signal terminal 134, a signal terminal 136, and a grounding terminal 138. At first, for providing the signal transmission function, the signal terminal 114 and the signal terminal 134 are coupled with each other via the wiring inside the cable unit 160. Similarly, the signal terminal 116 and the signal terminal 136 are coupled with each other via the wiring inside the cable unit 160. To be noted, since the connection 130 is used only for providing the drive current, the signal terminal 134, 136 of the connector 130 are not coupled to the signal terminal 124, 126, respectively, so that the layout of the signal terminal 134, 136 is neglected. Based on the descriptions above, the signal transmission cable 101 can be used as a signal transmission media between the computer host 10 and the external peripheral 20 in FIG. 1A. To be noted, the quantity of the signal terminals in any connector must be compliant with the connection interface type, for example, the USB connector comprises two signal terminals, i.e. D−1 signal terminal and D+1 signal terminal.

Referring to both FIG. 1A and FIG. 1B, for directly having the computer host 10 provide enough drive current to the external peripheral 20, the power terminal 112, the power terminal 122, and the power terminal 132 are coupled with each other via the wiring inside the cable unit 160. The grounding terminal 118, the grounding terminal 128, and the grounding terminal 138 are coupled with each other via the wiring inside the cable unit 160. Therefore, the connector 110 and the connector 130 of the signal transmission cable 101 can drain the electric power from the connector 12 and the connector 14 of the computer host 10, respectively, and also provide electric power to the connector 22 of the external peripheral 20 via the cable unit 160 and the connector 120 sequentially, so as to provide the needed drive current to the external peripheral 20. To be noted, when the external peripheral 20 needs more drive current, the quantity of the connectors in signal transmission cable 101 can be correspondingly increased, and the coupling method of the increased power terminals, grounding terminals, and signal terminals of the connector are the same as the one used in the connector 130, therefore, it is not described herein again.

Limited by the thickness of the body and internal space of the notebook, the notebook generally only has two PnP connectors (e.g. USB connectors). Accordingly, when the user uses the external peripheral such as the external mouse or external keyboard, one of the connectors in the notebook is occupied. In order to use the external optical disk drive that needs high drive current simultaneously, the signal transmission cable of the present invention further comprises one other connector for coupling to the external peripheral that only needs low drive current such as the external mouse or external keyboard mentioned above. Therefore, two external peripherals can be used simultaneously, including the external peripheral that needs high drive current (e.g. the external optical disk drive) and the external peripheral that needs low drive current (e.g. the external mouse or external keyboard).

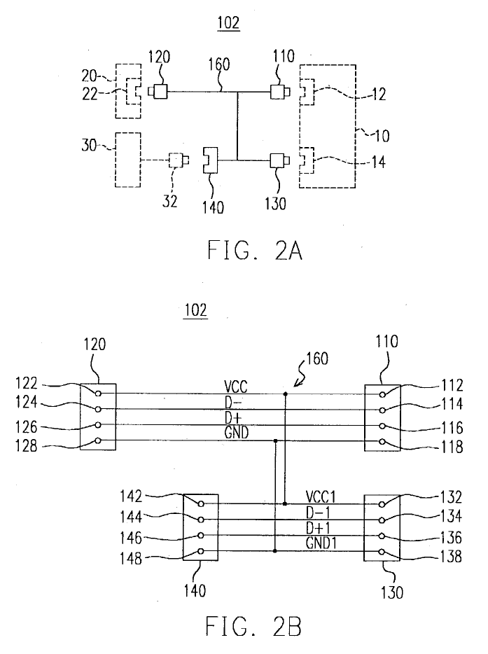

Based on the descriptions above, refer to FIG. 2A, which schematically shows a diagram of a second type signal transmission cable of a preferred embodiment according to the present invention. Compared to the signal transmission cable 101 in FIG. 1A, the signal transmission cable 102 further comprises a connector 140, and its connection interface type is the same as the connection interface type of the connector 130, e.g. the PnP connection interface type such as USB or IEEE 1394. Therefore, the external peripheral 30, e.g. the external mouse or external keyboard, has its connector 32 correspondingly coupled to the connector 140, so that the external peripheral 20 that needs high drive current and the external peripheral 30 that needs low drive current are coupled to the computer host 10 via the signal transmission cable 102, respectively. To be noted, when the connection 140 is a male connector, the corresponding connector 32 must be a female connector as shown in FIG. 2A. Contrariwise, when the connector 140 is a female connector, the corresponding connector 32 must be a male connector.

To clearly describe the circuit layout of the signal transmission cable 102 of FIG. 2A, please refer to FIG. 2B, which schematically shows an internal circuit layout diagram of the signal transmission cable in FIG. 2A. The USB connection interface is similarly exemplified herein. Compared with the signal transmission cable 101 in FIG. 1B, the connector 140 of the signal transmission cable 102 comprises a power terminal 142, a signal terminal 144, a signal terminal 146, and a grounding terminal 148. Similarly, for providing the signal transmission function, the signal terminals 144, 146 are coupled to the signal terminals 134, 136 respectively via the wiring inside the cable unit 160. Further, for providing the power supply function, the power terminal 142 is coupled to the power terminal 132 and the power terminal 112 via the wiring inside the cable unit 160. Further, the grounding terminal 148 is also coupled to the grounding terminal 138 and the grounding terminal 118 via the wiring inside the cable unit 160. Accordingly, please refer to FIG. 2A, besides being used as the signal transmission media between the computer host 10 and the external peripheral 20 that needs high drive current, the signal transmission cable 102 further can be used as the signal transmission media between the computer host 10 and the external peripheral 30 that needs low drive current.

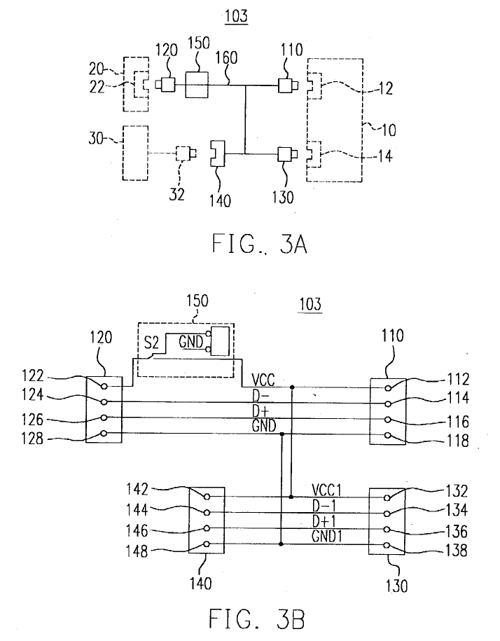

Referring to FIG. 2A, for example, when the external peripheral 20 is an external optical disk drive, since the initial drive current for the external optical disk drive 20 is rather large, and some specific type power switches (not shown) of the computer host 10 are rather sensitive to the output current that is too large, the power switch of the computer host 10 will turn off the current output from the connector having transient current, for example, turning off the current output from the connector 110 or the connector 130. In order to prevent the power switch of the computer host 10 from turning off the current output from the connector 12 or the connector 14 by accident, please refer to FIG. 3A, which schematically shows a diagram of a third type signal transmission cable of a preferred embodiment according to the present invention. Compared with the signal transmission cable 102 in FIG. 2A, the signal transmission cable 103 further comprises a power supply module 150. The power supply module 150 is coupled between the connector 110 and the connector 120, and is also coupled between the connector 130 and the connector 120 via the cable unit 160. Accordingly, when the external peripheral 20 is an external optical disk drive, since the initial drive current needed by the external peripheral 20 (i.e. the external optical disk drive) is rather larger, the power supply module 150 can be used to provide a rather larger current output in advance, so as to prevent the power switch of the computer host 10 from accidently turning off the current output from the connector 110 or the connector 130. Then, when the drive current needed by the external peripheral 20 (i.e. the external optical disk drive) is reduced, the power supply 150 can switch the operation of providing the drive current back to the computer host 10.

To clearly describe the circuit layout of the signal transmission cable 103 of FIG. 3A, please refer to FIG. 3B, which schematically shows an internal circuit layout diagram of the signal transmission cable in FIG. 3A. The USB connection interface is similarly exemplified herein. Compared with the signal transmission cable 102 in FIG. 2B, the signal transmission cable 103 further comprises a power supply module 150. The power supply module 150 is coupled between the connector 110 and the connector 120, and is also coupled between the connector 130 and the connector 120 via the cable unit 160. FIG. 3A schematically shows a state where the external peripheral 20 (i.e. the external optical disk drive) has just started and the power supply module 150 is providing the drive current to the external peripheral 20. The power supply module 150 may be a rechargeable battery module, so that the power supply module can recharge and save electric power needed for next time restarting the external peripheral 20 when it is in a state of not operating.

The signal transmission cable provided by the present invention mainly uses a plurality of connectors. The plurality of cable connectors connected with each other in parallel are respectively connected to a plurality of connectors of a computer host of a PC. Therefore, one other connector of the signal transmission cable can provide a multiple of the quantity of electric current supplied by each of the connectors of the computer host, so as to provide enough drive current to an external peripheral. The signal transmission cable of the present invention further comprises one other connector. Besides being used as the signal transmission media between the computer host and the external peripheral that needs high drive current (e.g. the external optical disk drive), the signal transmission cable also can be used as the signal transmission media between the computer host and the external peripheral that needs low drive current. The signal transmission cable further comprises a power supply module, e.g. a rechargeable battery module. When the computer host rejects providing an over current output, the power supply module of the signal transmission cable can provide enough drive current in time, so as to smoothly activate the external peripheral that needs high drive current connected by the signal transmission cable.

In summary, the signal transmission cable of the present invention can provide a few times the quantity of drive current to an external peripheral by using a plurality of connectors of the computer host of a PC. For the external optical disk drive, the signal transmission cable of the present invention can provide signal transmission and power supply functions to the external optical disk drive simultaneously. Therefore, it can efficiently simplify the accessory of the external optical disk drive and significantly facilitate the usage of the external optical disk drive.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. A signal transmission cable, at least comprising:
a first connector, having a first power terminal, a first grounding terminal, and at least a first signal terminal;
a second connector, having a second power terminal, a second grounding terminal, and at least a second signal terminal;
a third connector, having a third power terminal and a third grounding terminal; and
a cable unit, wherein the first power terminal, the second power terminal, and the third power terminal are coupled with each other via the cable unit, and the first grounding terminal, the second grounding terminal, and the third grounding terminal are coupled with each other via the cable unit, and the first signal terminal and the second signal terminal are coupled with each other via the cable unit.

2. The signal transmission cable of claim 1, wherein the first connector is one of a male connector and a female connector.

3. The signal transmission cable of claim 1, wherein the second connector is one of a male connector and a female connector.

4. The signal transmission cable of claim 1, wherein the third connector is one of a male connector and a female connector.

5. The signal transmission cable of claim 1, wherein the connection interface type of the first connector, the second connector, and the third connector is a USB.

6. The signal transmission cable of claim 1, further comprising a fourth connector, wherein the fourth connector comprises a fourth power terminal, a fourth grounding terminal, and at least a fourth signal terminal, and the third connector further comprises at least a third signal terminal, the fourth power terminal is coupled to the second power terminal via the cable unit, the fourth grounding terminal is coupled to the second power terminal via the cable unit, and the fourth signal terminal is further coupled to the second signal terminal via the cable unit.

7. The signal transmission cable of claim 6, wherein the third connector is one of a male connector and a female connector.

8. The signal transmission cable of claim 6, wherein the connection interface type of the fourth connector is a USB.

9. The signal transmission cable of claim 1, further comprising a power supply module, wherein the power supply module is coupled between the first power terminal and the second power terminal via the cable unit.

10. The signal transmission cable of claim 9, further comprising a power supply module, wherein the power supply module is coupled between the first power terminal and the third power terminal via the cable unit.

11. The signal transmission cable of claim 9, wherein the power supply module is a rechargeable battery module.
